(19) United States
(12) Patent Application Publication
(10) Pub. No.: US 2012/0198159 A1
(43) Pub. Date: Aug. 2, 2012

(54) INFORMATION PROCESSING DEVICE

(75) Inventors: Kunio Fujikawa, Kanagawa (JP); Tomohide Uchimi, Kanagawa (JP)

(73) Assignee: PANASONIC CORPORATION, Osaka (JP)

(21) Appl. No.: 13/500,494

(22) PCT Filed: Oct. 13, 2010
(86) PCT No.: PCT/JP2010/006098

§ 371 Date: Apr. 5, 2012

(30) Foreign Application Priority Data
Oct. 14, 2009 (JP) 2009-236941

(51) Int. Cl. G06F 12/08

(52) U.S. Cl. 711/118; 711/E12.017

(57) ABSTRACT

An information processing device of the invention includes a measurement section which detects the changes in the uses of a built-in memory and an external memory, and a control section which monitors the measurement result from the measurement section, changes the configuration of the built-in memory, transfers the data stored in the built-in memory and the external memory, and changes the external memory area and the built-in memory area used by the CPU and other bus master devices, wherein it is possible to detect the changes in the memory utilization efficiency that cannot be predicted by static analysis, and to maintain an optimal memory configuration.

### TECHNICAL FIELD

The present invention relates to a control technique of a memory and a bus which are used in order to improve the performance of an information processing device.

### BACKGROUND ART

In the related art, in a cache memory of an information processing device, a built-in memory that includes means for allocating a given area as a local memory and can have an optimal memory configuration for processing content has been known (PTL 1).

Generally, since such a built-in memory is operated at a higher speed and consumes less power than an externally connected memory, the performance of an information processing device improves by changing the memory configuration so that the built-in memory can be effectively used.

However, since an optimal memory configuration differs according to the processing content executed on the information processing device, it is difficult to maintain an optimal memory configuration.

As means for maintaining such an optimal memory configuration, a technique has been known in which processing content is analyzed during compiling, the processing content is divided into a few phases, an optimal memory configuration is derived in each phase, and codes for switching the memory configuration are created (PTL 2).

### CITATION LIST

### Patent Literature

(PTL 1) JP-A-2001-331370
[PTL 2] JP-A-2008-102733

### SUMMARY OF INVENTION

### Technical Problem

However, since the technique disclosed in PTL 2 is an analysis of static memory access during compiling, the technique can respond to a system in which a created program is operated solely occupying the CPU, but there is a problem in that the technique cannot detect a change in memory use efficiency caused by an operation of other bus master devices, a change in a power-saving state, an operation of other software, or the like, in order to have an optimal memory configuration.

For example, when a process from which performance improvement by cache hit is expected is executed solely by a CPU, an improvement of processing speed may be expected by using most of a built-in memory as a cache memory, but when another bus master device performs a process by making frequent access to the memory and the process holds higher priority than a process being performed by the CPU, it is more efficient to free up the cache memory by allocating the memory as a local memory so as to be used by the bus master device.

The invention takes the problem of the related art into consideration, and aims to provide an information processing device in which performance may be improved by dynamically detecting in advance a decrease in memory use efficiency of which operation cannot be predicted, and re-configuring the allocated sizes of the cache memory and the local memory.

### Solution to Problem

An information processing device of the invention includes a system-on-chip built-in memory (a first storage section), an external memory that is connected to the system-on-chip (a second storage section), a measurement section that detects a change in the usage states of the first storage section and the second storage section, a first change section that changes the configuration of the first storage section based on a measurement result of the measurement section, a transfer section that transfers data stored in the first storage section or the second storage section, and a second change section that changes an area of the first storage section or the second storage section to be used by a CPU or other bus master devices (an information processing section).

With this configuration, it is possible to dynamically change the configuration of the built-in memory based on a change in memory use efficiency, and to improve the processing speed, the strain on the bus of the external memory, and the power consumption by causing the CPU and other bus master devices to preferentially use the built-in memory to the external memory.

The measurement section of the configuration may be a measurement unit that measures the hit rate and the number of accesses of a cache memory. In this configuration, it is possible to improve a decrease in the processing speed of the CPU caused by insufficient cache memory. In addition, when there is excess, the cache memory can be freed up to other bus master devices as local memory.

The measurement section of this configuration may be a measurement unit that measures the load rate and the operation frequency of the CPU. In this configuration, when the operation rate of the CPU is high but there is insufficient cache memory, it is possible to ameliorate a decrease in the processing speed of the CPU caused by insufficiency of the cache memory. In addition, when the operation rate of the CPU is low and unnecessary cache memory is allocated to the CPU, the cache memory can be freed up to other bus master devices as local memory.

The measurement section of this configuration may be a measurement unit that measures the size of a VRAM and the frequency of updating the screen. In this configuration, when the VRAM usage state of a graphic controller is detected and display performance deteriorates by an increase in access to the VRAM, it is possible to improve deterioration in the display performance by increasing the size of the local memory and using the memory as the VRAM. In addition, when the size of the VRAM is reduced during the use of the local memory as the VRAM, the local memory can be freed up to other bus master devices or to the CPU as a cache memory.

The measurement section of this configuration may be a measurement unit that measures the kind of process and a change in the state of the process. In this configuration, the processing speed of the CPU can improve by predicting memory use efficiency based on a change in software that the CPU executes and having an optimal memory configuration. In addition, in a state where the CPU does not need much built-in memory, the cache memory can be freed up to other bus master devices as the local memory.

The measurement section of this configuration may be a measurement unit that measures the share of a bus band. In this configuration, by causing the bus master device (including the CPU) of which the processing speed is lowered due to insufficient bus band to use the built-in memory, the processing speed can improve. In addition, the built-in memory that is unnecessarily used by bus master devices with a low bus share can be freed up to other bus master devices.

The measurement section of this configuration may be a measurement unit that measures a working set of the CPU. In this configuration, the processing speed of the CPU can improve by allocating most of the cache memory to the CPU according to increases in the working set. In addition, when the working set decreases, the cache memory can be freed up to other bus master devices as the local memory.

The measurement section of this configuration may be a measurement unit that measures an interrupt event. In this configuration, an optimal memory configuration can be maintained corresponding to a change in a memory usage state triggered by an event.

### Advantageous Effects of Invention

With the information processing device of the invention, it is possible to detect a change in memory use efficiency which cannot be predicted with static analysis, to dynamically change the configuration of the first storage section, to move and re-arrange memory areas to be used by the information processing section, and to maintain an optimal memory configuration. Accordingly, it is possible to improve performance such as enhancement of processing speed of the information processing section, a reduction in the load on a bus band, and a drop in power consumption.

### BRIEF DESCRIPTION OF DRAWINGS

FIG. 1 is a schematic configuration diagram of an information processing device according to a first embodiment of the invention.

FIG. 2 is a flowchart describing an operation of the information processing device according to the first embodiment of the invention.

FIG. 3 is a schematic configuration diagram of an information processing device according to a second embodiment of the invention.

FIG. 4 is a flowchart describing an operation of the information processing device according to the second embodiment of the invention.

FIG. 5 is a diagram showing a memory configuration table of the information processing device according to the second embodiment of the invention.

FIG. 6 is a schematic configuration diagram of an information processing device according to a third embodiment of the invention.

FIG. 7 is a flowchart describing an operation of the information processing device according to the third embodiment of the invention.

FIG. 8 is a diagram showing a memory configuration table of the information processing device according to the third embodiment of the invention.

FIG. 9 is a schematic configuration diagram showing an information processing device according to a fourth embodiment of the invention.

FIG. 10 is a flowchart describing an operation of the information processing device according to the fourth embodiment of the invention.

FIG. 11 is a diagram showing a memory configuration table of the information processing device according to the fourth embodiment of the invention.

FIG. 12 is a schematic configuration diagram showing an information processing device according to a fifth embodiment of the invention.

FIG. 13 is a flowchart describing an operation of the information processing device according to the fifth embodiment of the invention.

FIG. 14 is a schematic configuration diagram showing an information processing device according to a sixth embodiment of the invention.

FIG. 15 is a flowchart describing an operation of the information processing device according to the sixth embodiment of the invention.

FIG. 16 is a schematic configuration diagram showing an information processing device according to a seventh embodiment of the invention.

FIG. 17 is a flowchart describing an operation of the information processing device according to the seventh embodiment of the invention.

FIG. 18 is a diagram showing a table of the state transition and the memory configuration of the information processing device according to the seventh embodiment of the invention.

### DESCRIPTION OF EMBODIMENTS

Hereinafter, embodiments of the invention will be described referring to the drawings.

### First Embodiment

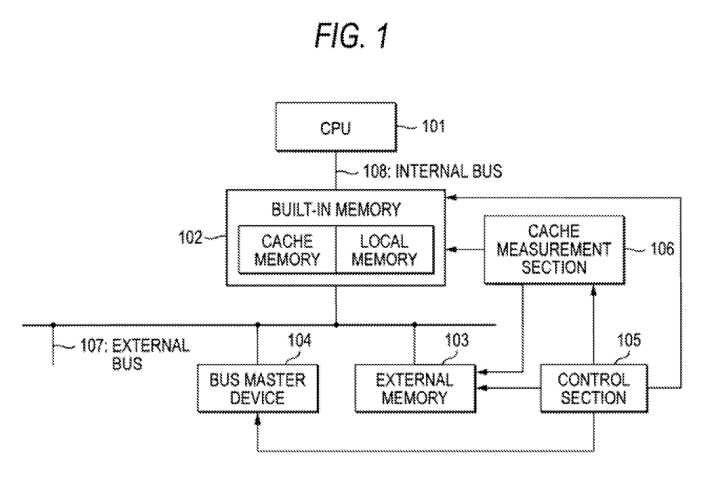

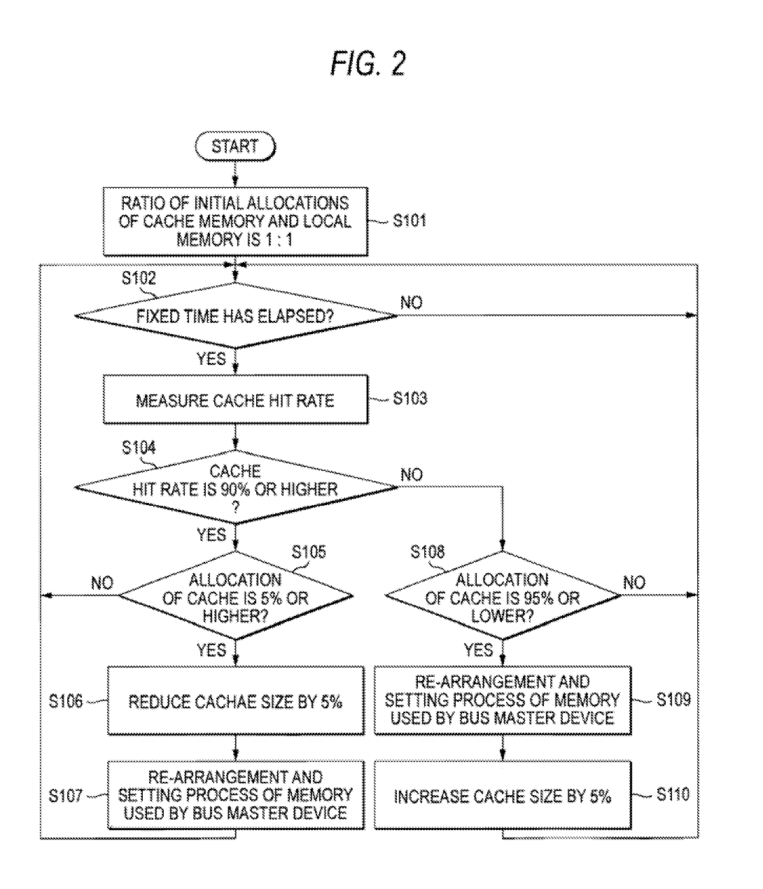

FIG. 1 is a schematic configuration diagram of an information processing device according to a first embodiment of the invention, and FIG. 2 is a flowchart describing an operation of the information processing device.

The information processing device according to the first embodiment of the invention includes, as shown in FIG. 1, a CPU 101 (the information processing section), a built-in memory 102 (the first storage section), an external memory 103 (the second storage memory), a bus master device 104 that is not a CPU (the information processing section), a cache measuring unit 106 that measures the state of the built-in memory 102, a control section 105 (the first change section, the transfer section, and the second change section), an internal bus 108 that connects the CPU 101 and the built-in memory 102, and an external bus 107 that connects the built-in memory 102, the bus master device 104, and the external memory 103.

In addition, the control section 105 is configured to include the first change section for changing the memory configuration of the built-in memory 102 when memory use efficiency is expected to improve by monitoring measurement values of the cache measuring means 106, the transfer section for transferring data of the built-in memory 102 and the external memory 103 that is being used by the CPU 101 and the bus master device 104 when the memory configuration is changed, and the second change section for causing the CPU 101 and the bus master device 104 to use the area of the transfer destination.

Next, the operation of the embodiment will be described using FIG. 2.

As shown in FIG. 2, in the starting process of the information processing device, the control section 105 performs initial allocation of the cache memory and the local memory of the built-in memory 102 (S101), and then, measures the cache hit rate at each fixed time (S102).

Herein, when the cache hit rate is a value equal to or higher than a certain level (for example, 90% or higher), the control section 105 determines that there is a probability that the size of the cache memory is excessive (S104), and thus, the control section performs a process of reducing the cache memory. Next, the control section determines the currently allocated size of the cache memory (S105), and when the size of the cache memory can be reduced (for example, when the cache allocated size of the built-in memory 102 is 5% or lower), the configuration of the built-in memory 102 is changed, and the size of the local memory is increased by reducing the size of the cache memory (for example, to 5%) (S106). Next, data of an area in the external memory 103 currently used by the bus master device 104 is transferred to the local memory in order to cause another bus master device to use the newly-allocated local memory so that the area of the transfer destination of data in the local memory is made to be used by changing settings of the bus master device 104.

On the other hand, when the cache hit rate is a value less than a certain level (for example, less than 90%), the control section 105 determines that there is a probability that the size of the cache memory is insufficient (S104), and thus, the control section performs a process of increasing the size of the cache memory. After the currently allocated size of the cache memory is determined (S108), and when the size of the cache memory can be increased (for example, when the cache allocated size of the built-in memory 102 is 95% or less), in order to allocated the size of the local memory to the cache memory, and thus, data of the area in the local memory currently used by the bus master device 104 is transferred to the external memory 103, and the area of the transfer destination of the data of the external memory 103 is made to be used by changing the settings of the bus master device 104 (S109). The size of the cache memory is increased (for example, by 5%) and the size of the local memory is reduced by changing the configuration of the built-in memory 102 (S110).

As such, according to the embodiment, since it is possible to change the configuration of the built-in memory 102 based on cache use efficiency, the processing speed of the CPU 101 can improve by increasing the size of the cache memory and reducing the size of the local memory when the size of the cache memory is insufficient. In addition, when excess cache memory is allocated, the size of the local memory is increased so as to be freed up to bus master device 104 by reducing the size of the cache memory.

### Second Embodiment

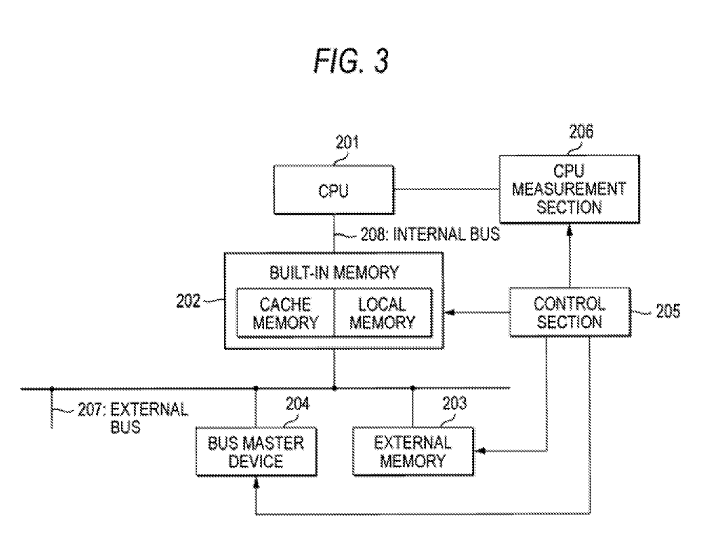

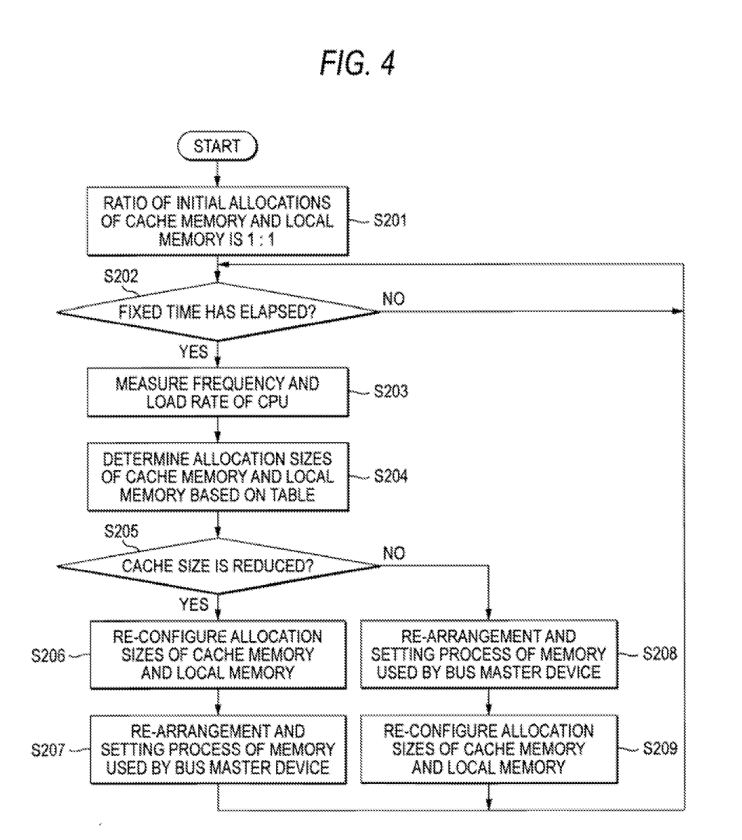

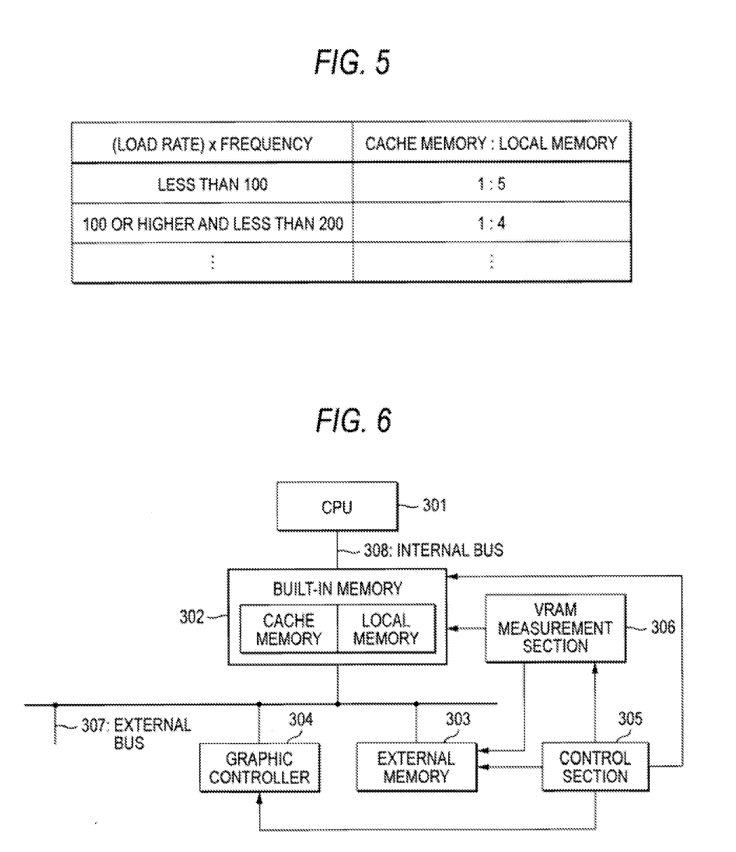

FIG. 3 is a schematic configuration diagram of an information processing device according to a second embodiment of the invention, FIG. 4 is a flowchart describing an operation of the same information processing device, and FIG. 5 is a table indicating a configuration of a cache memory and a local memory.

As shown in FIG. 3, the information processing device according to the second embodiment of the invention includes constituent elements 201 to 205, 207, and 208 that are the same as the constituent elements 101 to 105, 107, and 108 of the first embodiment, and a CPU measurement section 206 that measures a state of a CPU 201.

Next, the operation of the embodiment will be described using FIG. 4.

As shown in FIG. 4, in the starting process of the information processing device, the control section 205 performs initial allocation of the cache memory and the local memory of the built-in memory 202 (S201), and then measures (S203) the frequency and the load rate of the CPU at each fixed time (S202).

The control section 205 determines the allocation size of the cache memory and the local memory using the table shown in FIG. 5 based on the frequency and the load rate of the CPU 201 (S204). Herein, the lower the frequency and the load rate of the CPU 201 and the lower the state the operation rate of the CPU is in, the more the frequency of memory access of the CPU 201 decreases and the cache memory becomes unnecessary; conversely, the higher the frequency and the load rate of the CPU 201 and the higher the state the operation rate of the CPU is in, the more the frequency of memory access of the CPU 201 increases and the cache memory becomes necessary. For this reason, the table is constructed such that the size of the cache memory becomes large if the frequency and the load rate of the CPU 201 are high, and the size of the cache memory becomes small if the frequency and the load rate of the CPU 201 are low.

Next, the control section 205 compares the currently allocated size of the cache memory and the size determined this time (S205), and when the size of the cache memory is to be reduced, the control section changes the configuration of the built-in memory 202, reduces the size of the cache memory, and increases the size of the local memory (S206). In order to cause the bus master device to use the newly allocated local memory, data of the area in the external memory 203 currently used by the bus master device 204 is transferred to the local memory, and the area of the transfer destination of the data of the local memory is made to be used by changing settings of the bus master device 204 (S207). When the size of the cache memory is increased, in order to allocate the local memory to the cache memory, data of the area in the local memory currently used by the bus master device 204 is transferred to the external memory 203, and the area of the transfer destination of the data of the external memory 203 is made to be used by changing the settings of the bus master device 204 (S208). The size of the cache memory is increased and the size of the local memory is reduced by changing the configuration of the built-in memory 202 (S209).

As such, according to the embodiment, since it is possible to change the configuration of the built-in memory 202 based on the operation state of the CPU 201, when the operation rate of the CPU 201 is low and the cache memory is not necessary, such as in a low power consumption state or a resting state, the size of cache memory is reduced, and the size of the local memory is increased so as to be freed up to the bus master device 204. In addition, when the operation rate of the CPU 201 is raised and therefore the CPU 201 needs the cache memory, the size of the local memory is reduced, and the size of the cache memory is increased so as to improve the processing speed of the CPU 201.

### Third Embodiment

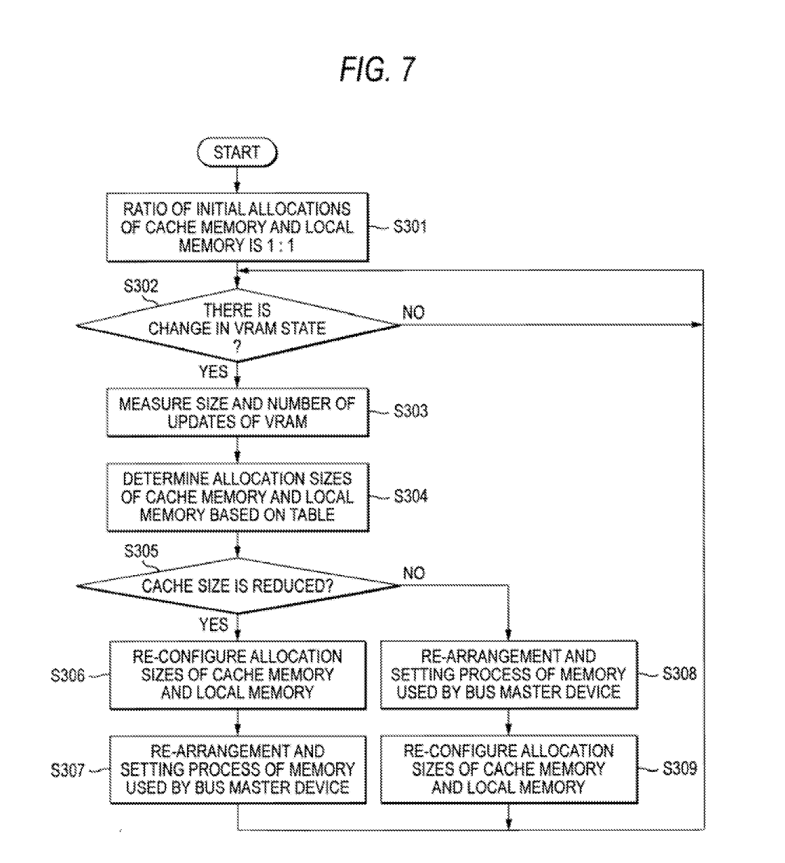

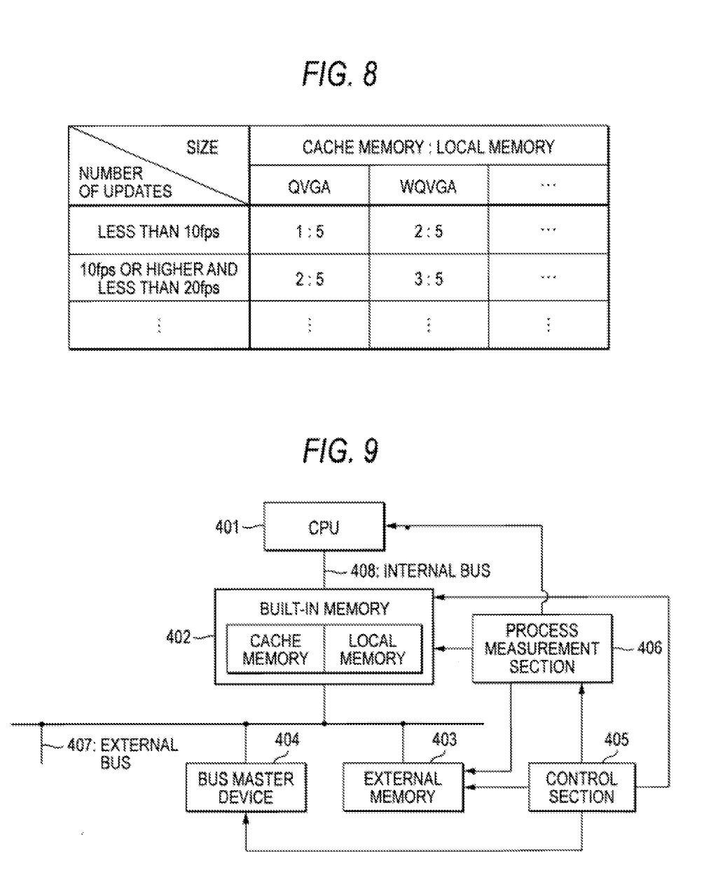

FIG. 6 is a schematic configuration diagram of an information processing device according to a third embodiment of the invention, FIG. 7 is a flowchart describing an operation of the same information processing device, and FIG. 8 is a table showing a configuration of cache memory and a local memory.

As shown in FIG. 6, the information processing device according to the embodiment includes constituent elements 301 to 303, 305, 307, and 308 that are the same as the constituent elements 101 to 103, 105, 107, and 108 of the first embodiment, and a graphic controller 304 (the information processing section), a built-in memory 302, and a VRAM measurement section 306 that measures the state of a VRAM of the external memory 303.

Next, the operation of the embodiment will be described using FIG. 7.

As shown in FIG. 7, in the starting process of the information processing device, the control section 305 performs initial allocation of the cache memory and the local memory of the built-in memory 302 (S301), and then measures (S303) the size and the number of updates of the VRAM at each fixed time (S302).

The control section 305 determines the allocation sizes of the cache memory and the local memory using the table shown in FIG. 5 based on the size of the VRAM and the number of updates (S304).

The frequency of memory access of the graphic controller 304 decreases as the size of the VRAM is small and the number of updates is low, and on the contrary, the frequency increases as the size of the VRAM is large and the number of updates is high. In order to prevent deterioration of drawing performance when the memory access of the graphic controller 304 increases, it is better to increase the allocated size of the local memory for the VRAM. For this reason, the table is constructed such that the size of the local memory increases if the size of the VRAM increases and the number of updates is raised, and the size of the local memory decreases if the size of the VRAM increases and the number of updates is raised.

The following control (S305 to S309) is the same as that (S205 to S209) of the second embodiment except for the graphic controller 304 replacing the bus master device 204 of the second embodiment.

As such, according to the embodiment, since it is possible to change the configuration of the built-in memory 302 based on the state of the VRAM, by using the local memory as the VRAM after increasing the size thereof and reducing the size of the cache memory when the screen size is large and the number of drawing updates is high, it is possible to enhance the access performance of the VRAM, thereby maintaining the drawing performance of the graphic controller 304 to a certain degree. In addition, when the screen side is small, the number of drawing updates is low, and therefore, the drawing performance of the graphic controller 304 is allowed to be low, and it is possible to enhance the processing speed of the CPU 301 by reducing the size of the local memory allocated as the VRAM and increasing the size of the cache memory.

### Fourth Embodiment

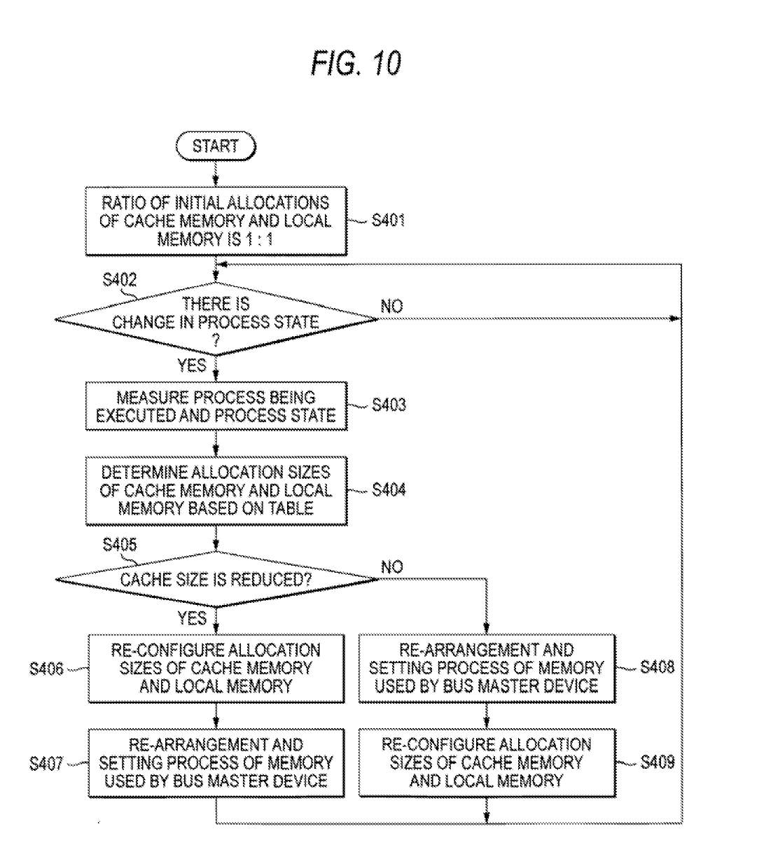

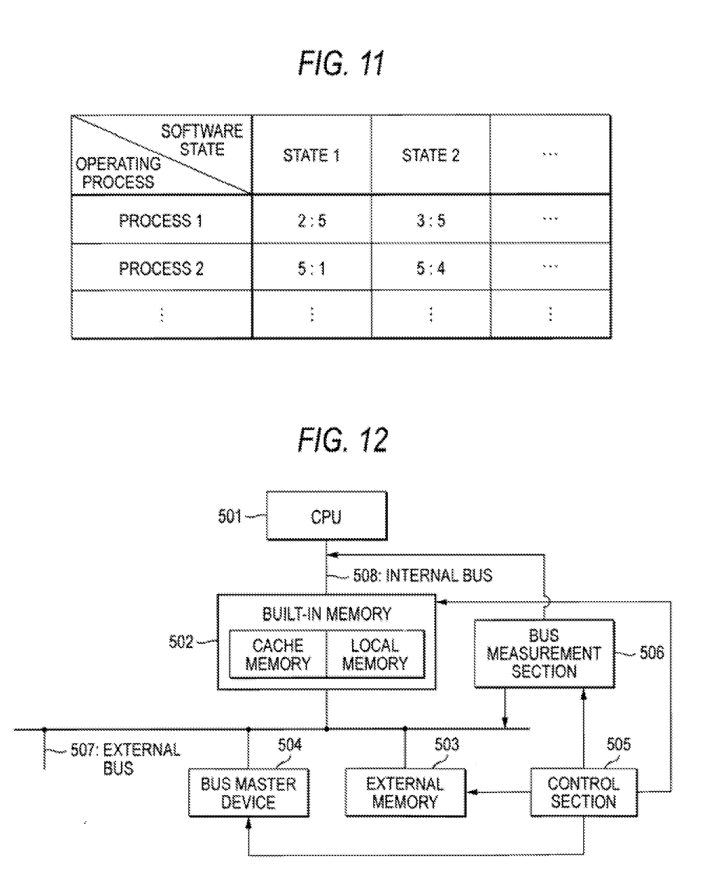

FIG. 9 is a schematic configuration diagram showing an information processing device according to a fourth embodiment of the invention, FIG. 10 is a flowchart describing an operation of the same information processing device, and FIG. 11 is a table showing a configuration of a cache memory and a local memory.

As shown in FIG. 9, the information processing device according to the fourth embodiment includes constituent elements 401 to 405, 407, and 408 that are the same as the constituent elements 101 to 105, 107, and 108 of the first embodiment, and a process measurement section 406 that measures the state of a process from the CPU 401, the built-in memory 402, and the external memory 403.

The process measurement section 406 is configured to measure the state of a process by measuring the CPU 401, the built-in memory 402, and the external memory 403 with an OS executed by the CPU 401.

Next, the operation of the embodiment will be described using FIG. 10.

As shown in FIG. 10, in the starting process of the information processing device, the control section 405 performs initial allocation of the cache memory and the local memory of the built-in memory 402 (S401), and then monitors a change in the state of a process (S402). If a change in the state of a process is detected, the process being executed and the state thereof are measured (S403).

The control section 405 determines the allocation sizes of the cache memory and the local memory using the table shown in the drawing based on the process being executed and the state thereof (S404).

Memory access of the CPU 401 differs according to processes executed, and differs according to the state of the process even in the same process. A polling process may use a small size of the cache memory because the process does not use the memory even though the process takes a share of the CPU 401 for a long period of time. For this reason, the table is constructed so that the size of the cache memory becomes large in the execution and state of the process that requires plenty of memory access, and the size of the cache memory becomes small in the execution and state of the process that requires little memory access.

The following control (S405 to S409) is the same as that of the second embodiment (S205 to S209).

As such, according to the embodiment, since the configuration of the built-in memory 402 can be changed based on the state of a process, the memory access performance of the process can improve by increasing the size of the cache memory and reducing the size of the local memory during the execution of the process that requires plenty of memory access. In addition, during the execution of the process that requires little memory access, the local memory can be freed up to the bus master device 404 by increasing the size of the local memory and reducing the size of the cache memory.

### Fifth Embodiment

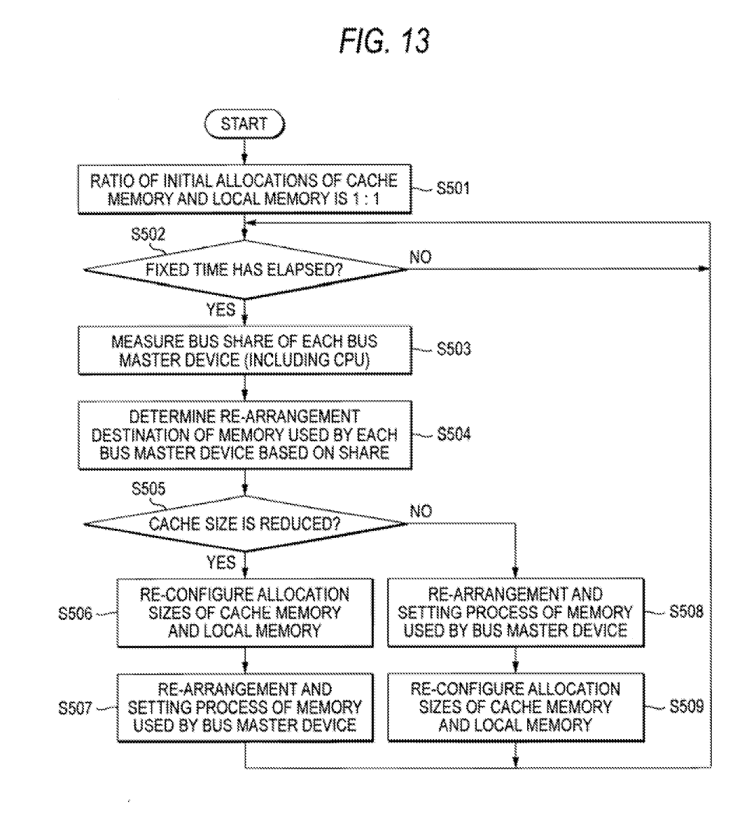

FIG. 12 is a schematic configuration diagram showing an information processing device according to a fifth embodiment of the invention, and FIG. 13 is a flowchart describing an operation of the same information processing device.

As shown in FIG. 12, the information processing device according to the fifth embodiment includes constituent elements 501 to 505, 507, and 508 that are the same as the constituent elements 101 to 105, 107, and 108 of the first embodiment, and a bus measurement section 506 that measures the external bus 507 and the internal bus 508.

The bus measurement section 506 is configured so as to measure the share of a bus by monitoring a signal line of the external bus 507 and the internal bus 508 and counting the bus master (including the CPU 501) that takes a share of the bus at each fixed time.

Next, the operation of the embodiment will be described using FIG. 13.

As shown in FIG. 13, in the starting process of the information processing device, the control section 505 performs initial allocation of the cache memory and the local memory of the built-in memory 502 (S501), and then measures (S503) the bus share of each bus master at each fixed time (S502).

The control section 505 distributes the memory area used by each bus master to the built-in memory 502 and the external memory 503 based on the bus share of each bus master. At this time, since the built-in memory 502 has high performance, the built-in memory 502 is allocated preferentially to a bus master that makes frequent access to a memory with a high bus share. When the bus master that uses the built-in memory 502 is the CPU 501, the cache memory is allocated as the area to use, and when the bus master is the bus master device 504, the local memory is allocated as the area to use. Then, when the size and the bandwidth of the built-in memory 502 are insufficient, an area of the external memory 503 is allocated (S504).

The following control (S505 to S509) is the same as that of the second embodiment (S205 to S209).

As such, according to the embodiment, based on the usage state of a bus, it is possible to change the configuration of the built-in memory 502, to disperse the occupancy of the bus into the internal bus 508 and the external bus 507, to improve a decrease in the processing speed when the bus bandwidth is insufficient and the performance of the bus master is not delivered, and to preferentially use the high-performance built-in memory 502.

Furthermore, in the embodiment, there may be provided a plurality of bus master devices that measure the bus measurement section 506. With this configuration, used buses of the plurality of bus master devices such as DSP, DMA, and the like compete with each other, and thus, a decrease of the processing speed can improve when the performance is not delivered.

### Sixth Embodiment

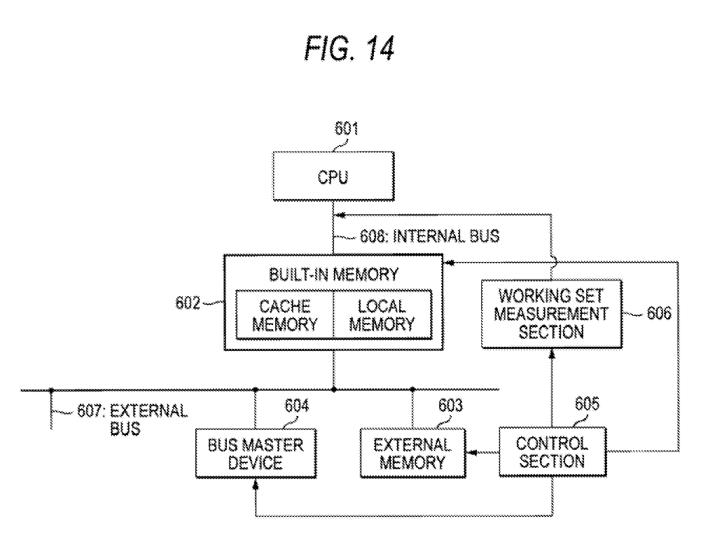

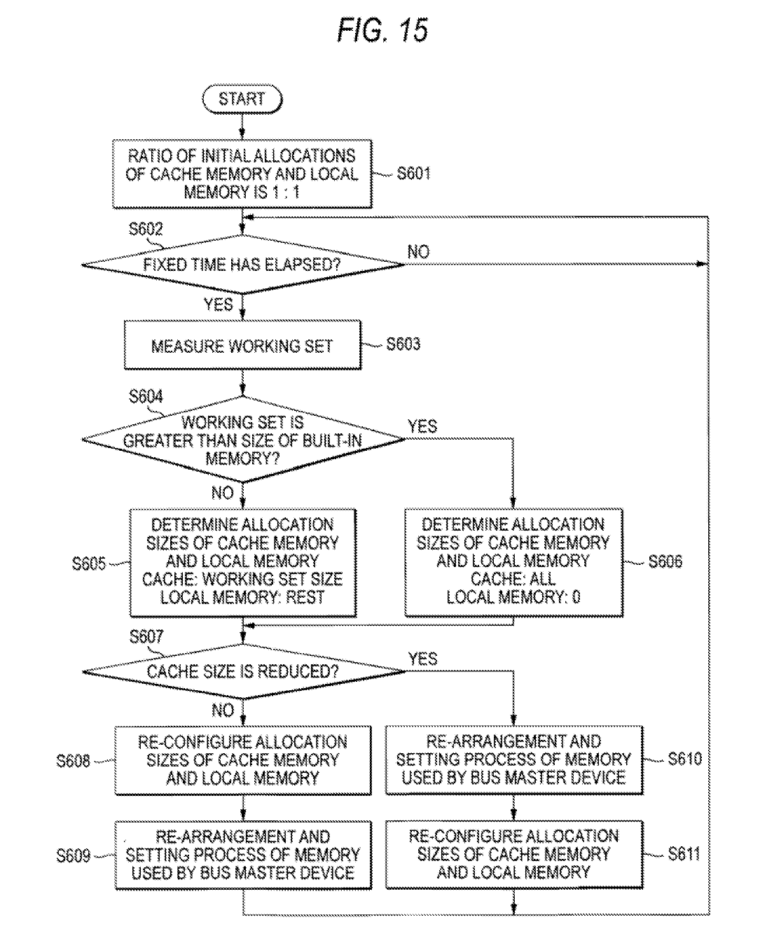

FIG. 14 is a schematic configuration diagram showing an information processing device according to a sixth embodiment of the invention, and FIG. 15 is a flowchart describing an operation of the same information processing device.

As shown in FIG. 14, the information processing device according to the sixth embodiment includes constituent elements 601 to 605, 607, and 608 that are the same as the constituent elements 101 to 105, 107, and 108 of the first embodiment, and a working set measurement section 606 that measures a working set from the internal bus 608 to the CPU 601.

The working set measurement section 606 is configured to count an address signal of the internal bus 608 at each fixed time and to measure the working set for the time being.

Next, the operation of the embodiment will be described using FIG. 15.

As shown in FIG. 15, in the starting process of the information processing device, the control section 605 performs initial allocation of the cache memory and the local memory of the built-in memory 602 (S601), and then measures (S603) the working set at each fixed time (S602).

It is wasteful for the size of the cache memory allocated to the CPU 601 to be equal to or larger than the size of the working set. For this reason, the control section 605 compares the working set of the CPU 601 to the size of the built-in memory 602 (S604), and when the working set is equal to or smaller than the size of the built-in memory 602, the control section determines that the size of the cache memory is the same as that of the working set, and the remainder thereof is for the local memory (S605), and when the working set exceeds the size of the built-in memory 602, the control section determines that the size of the cache memory is the entire built-in memory 602, and the local memory is 0.

The following control (S607 to S611) is the same as that of the second embodiment (S205 to S209).

As such, according to the embodiment, based on the working set, it is possible to change the configuration of the built-in memory 602, to allocate a necessary portion of the cache memory to the CPU 601, and to improve the processing speed of the CPU 601. In addition, an unnecessary cache size can be allocated to the local memory so as to be freed up to the bus master device 604.

### Seventh Embodiment

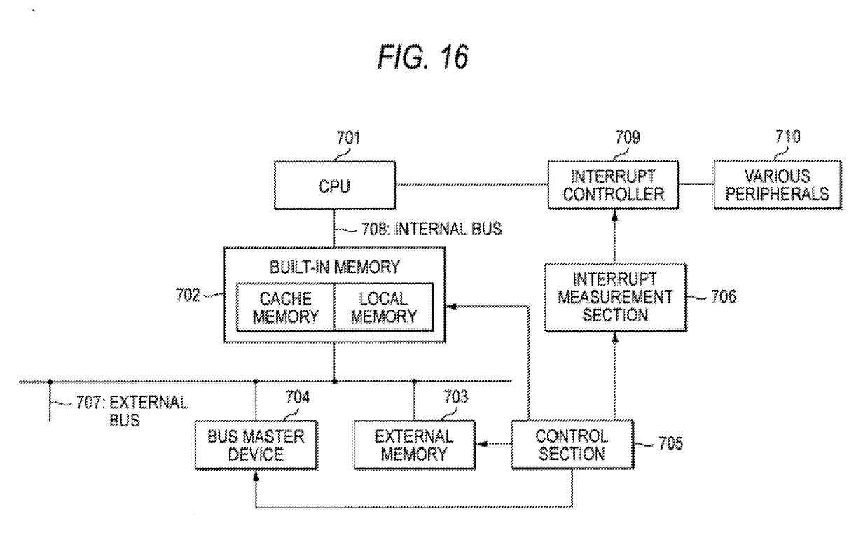

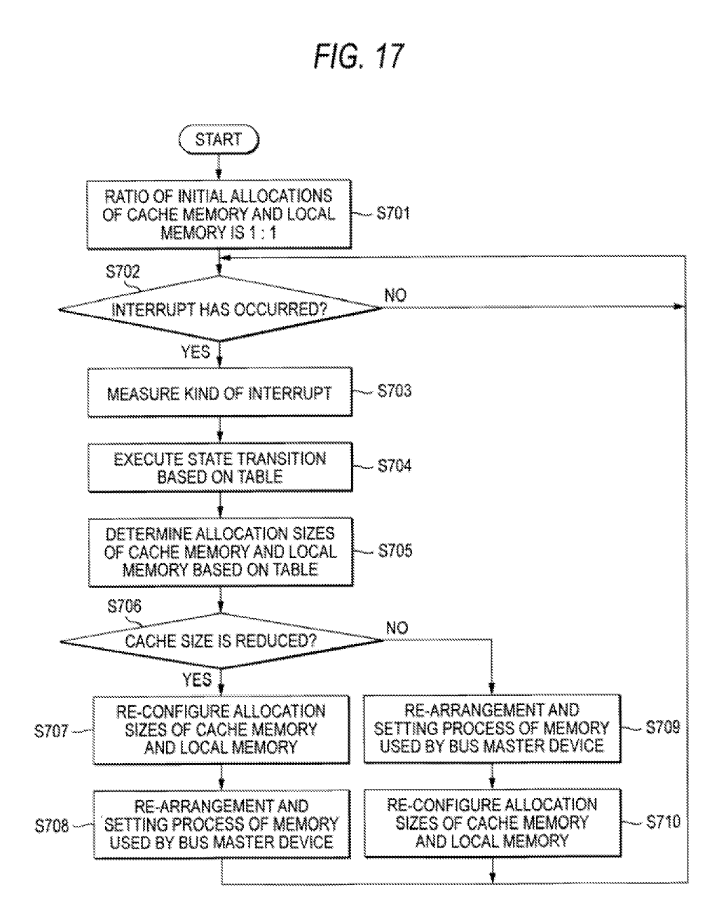

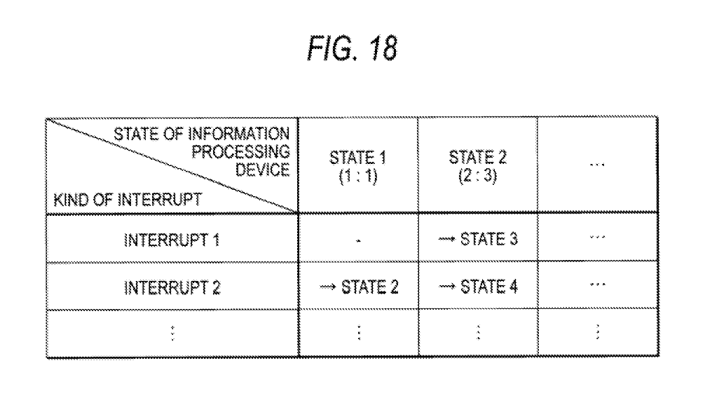

FIG. 16 is a schematic configuration diagram showing an information processing device according to a seventh embodiment of the invention, FIG. 17 is a flowchart describing an operation of the same information processing device, and FIG. 18 is a table showing a state transition and a configuration of a cache memory and a local memory.

As shown in FIG. 16, the information processing device according to the seventh embodiment includes constituent elements 701 to 705, 707, and 708 that are the same as the constituent elements 101 to 105, 107, and 108 of the first embodiment, various peripherals 710, an interrupt controller 709 that interrupts the CPU 701 from a signal of each peripheral 710, and an interrupt measurement section 706 that measures interrupts caused by the interrupt controller 710.

Next, the operation of the embodiment will be described using FIG. 17.

As shown in FIG. 17, in the starting process of the information processing device, the control section 705 performs initial allocation of the cache memory and the local memory of the built-in memory 702 (S701), and then measures (S703) the kind of interrupt when the states of the various peripherals 710 change and the interrupt controller 709 interrupts the CPU 701 (S702).

The control section 705 performs state transition using the table based on the current state and the kind of interrupt (S704), and determines the allocation sizes of the cache memory and the local memory (S705). The table is constructed so as to have an optimal memory configuration based on the current state and the interrupt caused. An example thereof is shown below. When key interrupt occurs in a power saving state of the information processing device, most of the cache is allocated to the CPU 701 for the restoration process thereof. On the other hand, when key interrupt occurs in a moving image reproduction state of the information processing device, a certain size of the local memory used by the graphic controller and the bus master device 704 such as a DSP, or the like is secured in order to secure the memory access performance thereof.

The following control (S706 to S710) is the same as that of the second embodiment (S205 to S209).

As such, according to the embodiment, since it is possible to determine the state of the information processing device based on the kind of interrupt and to maintain the configuration of the built-in memory appropriate for the state, the memory access performance for the processing performance of the CPU and other bus master can be secured.

The present invention has been described in detail and referring to specific embodiments, but it is obvious for a person skilled in the art that the invention can be variously modified and adjusted without departing from the scope and the gist of the invention.

The present application is based on Japanese Patent Application filed on Oct. 14, 2009 (Japanese Patent Application No. 2009-236941), and the content thereof is incorporated herein by reference.

### INDUSTRIAL APPLICABILITY

The information processing device of the invention includes first storage section of which an arbitrary area can be used by being switched to a local memory or a cache memory, a second storage section that is different from the first storage section, a measurement section for detecting a change in the usage states of the first storage section and the second storage section, a first change section for changing the configuration of the first storage section based on the measurement result of the measurement section, a transfer section for transferring data stored in the first storage section or the second storage section, and a second change section for changing an area of the first storage section or the second storage section that the information processing section uses.

A control section can change to an optimal memory configuration based on the state of the information processing device because the control section monitors a measurement result of the measurement section and includes the first change section, the transfer section, and the second change section.

Therefore, even an information processing device of which a memory usage state significantly differs according to processing content can secure the processing performance and is useful for an information processing device such as a mobile telephone, a PC, or the like that performs a process of real-time decoding of moving images or audio data, a process in a resting state, or the like.

### REFERENCE SIGNS LIST

101, 201, 301, 401, 501, 601, 701 CPU
102, 202, 302, 402, 502, 602, 702 built-in memory
103, 203, 303, 403, 503, 603, 703 external memory
104, 204, 404, 504, 604, 704 bus master device
304 graphic controller
105, 205, 305, 405, 505, 605, 705 control section
106 cache measurement section
107, 207, 307, 407, 507, 607, 707 external bus
108, 208, 308, 408, 508, 608, 708 internal bus
206 CPU measurement section
306 VRAM measurement section
406 process measurement section
506 bus measurement section
606 working set measurement section
706 interrupt measurement section
709 interrupt controller
710 various peripherals

1. An information processing device comprising:
a first storage section in which a given area can be switchably used as a local memory or a cache memory;
a second storage section that is different from the first storage section;
an information processing section that uses the first storage section or the second storage section;
a measurement section that detects a change in usage states of the first storage section and the second storage section;
a first change section that changes a configuration of the first storage section based on a measurement result of the measurement section;
a transfer section that transfers data stored in the first storage section or the second storage section; and
a second change section that at least changes at least a part of an area of the first storage section or the second storage section used by the information processing section from the first storage section to the second storage section,
wherein the measurement section includes a measurement unit for measuring at least a working set size of the information processing section.

2. (canceled)

3. The information processing device according to claim 17 wherein the measurement unit measures the size of a VRAM or a display updating frequency.

4.-16. (canceled)

17. An information processing device comprising:
a first storage section in which a given area can be switchably used as a local memory or a cache memory;
a second storage section that is different from the first storage section;
an information processing section that uses the first storage section or the second storage section;
a measurement section that detects a change in usage states of the first storage section and the second storage section;
a first change section that changes a configuration of the first storage section based on a measurement result of the measurement section;
a transfer section that transfers data stored in the first storage section or the second storage section; and
a second change section that at least changes at least a part of an area of the first storage section or the second storage section used by the information processing section from the first storage section to the second storage section,
wherein the measurement section includes a measurement unit for measuring at least a display state.
